(19) United States
(12) Patent Application Publication
(10) Pub. No.: US 2025/0249655 A1
(43) Pub. Date: Aug. 7, 2025

(54) RECYCLABLE LAMINATE

(71) Applicants: Chen-Cheng HUANG, Taipei City (TW); Pao-Hao HUANG, Taipei City (TW); Pao-Han HUANG, Taipei City (TW)

(72) Inventors: Chen-Cheng HUANG, Taipei City (TW); Pao-Hao HUANG, Taipei City (TW); Pao-Han HUANG, Taipei City (TW)

(21) Appl. No.: 19/083,082

(22) Filed: Mar. 18, 2025

Related U.S. Application Data
(63) Continuation-in-part of application No. 17/083,047, filed on Oct. 28, 2020, now abandoned.

(30) Foreign Application Priority Data
Nov. 4, 2019 (TW) 108139939

(51) Int. Cl. B32B 5/26; B32B 7/06; B32B 37/00; B32B 37/06; B32B 37/14

(52) U.S. Cl. CPC B32B 5/262; B32B 7/06; B32B 37/065; B32B 2037/0092; B32B 2037/148; B32B 2250/02; B32B 2250/24; B32B 2305/026; B32B 2305/188; B32B 2307/724; B32B 2307/7265; B32B 2398/20; B32B 2437/00

(57) ABSTRACT

A recyclable laminate includes a first layer that includes a first inner surface having a bonded region, and a second layer that includes a second inner surface. The second inner surface includes yarns which are distributed thereon and which form micropores. The bonded region extends into a portion of the micropores to wrap corresponding ones of the yarns, so that the first inner surface is partially fusion bonded to the second inner surface at the bonded region and and partially unbonded to the second inner surface at a region other than the bonded region. The first thin layer and the second thin layer are made of a recyclable material, and are structurally different from each other. A recyclable garment made from the recyclable laminate is also provided.

### CROSS-REFERENCE TO RELATED APPLICATION

This is a continuation-in-part application of U.S. patent application Ser. No. 17/083,047, filed on Oct. 28, 2020, which claims priority to Taiwanese Invention patent application Ser. No. 10/813,9939, filed on Nov. 4, 2019. The aforesaid applications are incorporated by reference herein in their entirety.

### FIELD

The present disclosure relates to a recyclable laminate, and more particularly to a recyclable laminate made of recyclable material that can be melt-bonded to form a garment or a garment accessory.

### BACKGROUND

With advancement of textile technology, selection of raw materials for manufacturing textile products (e.g., garments) can be more diverse, so as to confer more functions to the textile products according to practical requirements. However, a recycling process of such garments is troublesome, and remains a problem to be solved. For example, in a process for manufacturing a garment made from a recyclable material such as polyethylene terephthalate (PET) bottles, the bottles, after being collected, are sorted according to colors, then subjected to disintegrating, cleaning, impurity removing, and dehydrating steps so as to be processed into cleaned polyester granules, followed by melt spinning and drawing to form yarns, which are subsequently made into fabrics and garments. When such garments, after being used, are recycled, the abovementioned steps of the manufacturing process are also required, and the previously encountered problems in the steps of sorting and impurity removing would be further amplified, requiring more steps for subsequent recycling process.

On the other hand, if a garment requires breathability and waterproofing functions or multiple accessories for holding things, a conventional method for manufacturing such garment includes bonding a breathable and waterproof microporous membrane layer to a fabric sheet using polyurethane reactive hot melt adhesives (PUR), which is also used for bonding garment accessories such as pockets, zippers, water sealing tapes, etc. to the garment. However, since PUR cannot be recycled, the discarded PUR would cause worrisome environmental pollution, in addition to the abovementioned problems of the recycling process. In addition, garments made by bonding using PUR faces other problems, such as poor resistance to washing and rubbing, etc.

In view of the foregoing, those skilled in the art endeavor to improve the structure of recyclable laminate so as to solve the aforesaid problems related to the recycling process, and poor resistance to washing and rubbing, etc.

### SUMMARY

Therefore, an object of the present disclosure is to provide a recyclable laminate that can alleviate at least one of the drawbacks of the prior art.

The recyclable laminate includes a first layer that includes a first inner surface having a bonded region, and a second layer that includes a second inner surface facing the first inner surface. The second inner surface includes a plurality of yarns distributed thereon. The plurality of yarns are interlaced with one another to form micropores therebetween. The bonded region of the first inner surface extends into a portion of the micropores of the plurality of yarns, so that the first inner surface is partially fusion bonded to the second inner surface at the bonded region and partially unbonded to the second inner surface at a region other than the bonded region. The first layer and the second layer are made of a recyclable material, and are structurally different from each other.

Another object of the present disclosure is to provide a recyclable garment that can alleviate at least one of the drawbacks of the prior art.

The recyclable garment includes a first thin layer that includes a first inner surface having a bonded region, and a second thin layer that includes a second inner surface facing the first inner surface. The second inner surface includes a plurality of yarns distributed thereon. The plurality of yarns are interlaced with one another to form micropores therebetween. The bonded region of the first inner surface extends into a portion of the micropores of the plurality of yarns to wrap corresponding ones of the plurality of yarns, so that the first inner surface is partially fusion bonded to the second inner surface at the bonded region in absence of an adhesive therebetween, and partially unbonded to the second inner surface at a region other than the bonded region. The first layer is a breathable waterproof thermoplastic microporous membrane, and the second layer is a woven fabric made of a thermoplastic material.

### BRIEF DESCRIPTION OF THE DRAWINGS

Other features and advantages of the present disclosure will become apparent in the following detailed description of the embodiments with reference to the accompanying drawings, of which:

FIG. 1 is a perspective view illustrating an embodiment of a recyclable laminate according to the present disclosure.

FIG. 2 is a schematic view illustrating a process for manufacturing the embodiment of the recyclable laminate according to the present disclosure.

FIG. 3 is a schematic view illustrating structural relationship between a first layer and a second layer of the recyclable laminate.

### DETAILED DESCRIPTION

Before the present disclosure is described in greater detail, it should be noted that where considered appropriate, reference numerals or terminal portions of reference numerals have been repeated among the figures to indicate corresponding or analogous elements, which may optionally have similar characteristics.

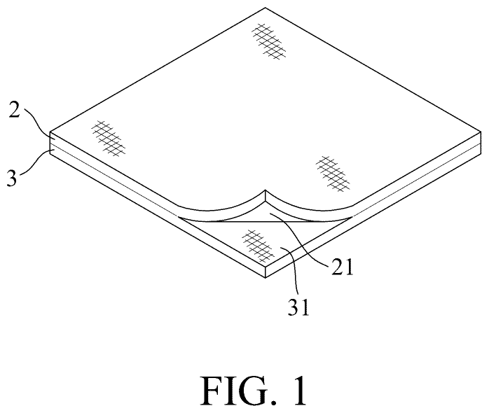

Referring to FIG. 1, a recyclable laminate according to an embodiment of the present disclosure includes a first layer 2 and the second layer 3 that is partially fusion-bonded to the first layer 2. The first layer 2 and the second layer 3 are made of a recyclable material such as a thermoplastic material, and are structurally different from each other. Examples of the thermoplastic material may include, but are not limited to, polyethylene terephthalate, polypropylene, thermoplastic polyurethane, polyethylene, polyether ester, and thermoplastic polyamide.

The thermoplastic materials used for making the first layer 2 and the second layer 3 may be of a similar type, so as to simplify process parameters of fusion bonding for producing a composite finished product or laminate and to enhance strength of fusion bonding, as well as to simplify recycling of the product or laminate and to improve purity of the recycled thermoplastic material, thereby facilitating and increasing the possibility of repeatedly recycling the thermoplastic materials.

The recyclable laminate of the present disclosure may be a combination of two or more fabric layers, or a combination of a membrane and one or more fabric layers. In certain embodiments, the first layer 2 is a membrane which has breathability and waterproof characteristics, and the second layer 3 is a fabric. In other embodiments of the recyclable laminate, the first layer 2 and the second layer 3 are fabrics made of thermoplastic materials of a similar type or different types.

When the first layer 2 and the second layer 3 are made of a similar type of the thermoplastic material, the first layer 2 and the second layer 3 may be directly connected to each other by partial fusion bonding without use of an adhesive therebetween.

Examples of a method used for partial fusion bonding of the first inner surface 21 to the second inner surface 31 include, but are not limited to, hot pressing, hot air blowing, and high frequency bonding. However, when the first layer 2 and the second layer 3 are structurally and materially different from each other, the physical properties thereof, such as melting temperatures, will be different, and fusion bonding method such as high frequency bonding or ultrasonic bonding, cannot be utilized. Therefore, an adhesive is required to form the recyclable laminate. However, considering factors such as ease of recycling and repeatability for reuse, the adhesive to be used should be a thermoplastic adhesive that is of the same thermoplastic type as one of the first layer 2 and the second layer 3 and that is made from a base material having the same thermoplastic type as one of the first layer 2 and the second layer 3, to which a hot-melt resin and an organic functional material are added.

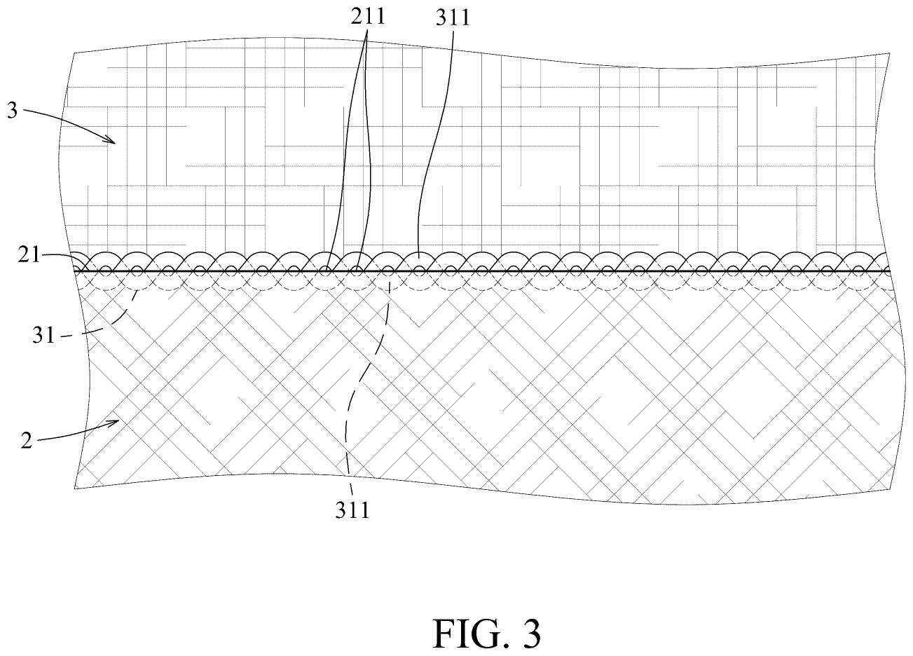

Referring to FIG. 3, in certain embodiments, the first layer 2 includes a first inner surface 21 having a bonded region 211. The second layer 3 includes a second inner surface 31 which faces the first inner surface 21 and which includes a plurality of yarns 311 distributed thereon. The plurality of yarns 311 are interlaced with one another to form micropores 312 therebetween. The bonding region 211 of the first inner surface 21 extends into the micropores 312 of the plurality of yarns 311 to wrap corresponding ones of the plurality of yarns 311, so that the first inner surface 21 is partially fusion-bonded to the second inner surface 31 at the bonding region 211, and is partially unbonded to the second inner surface 31 at a region other than the bonded region 211.

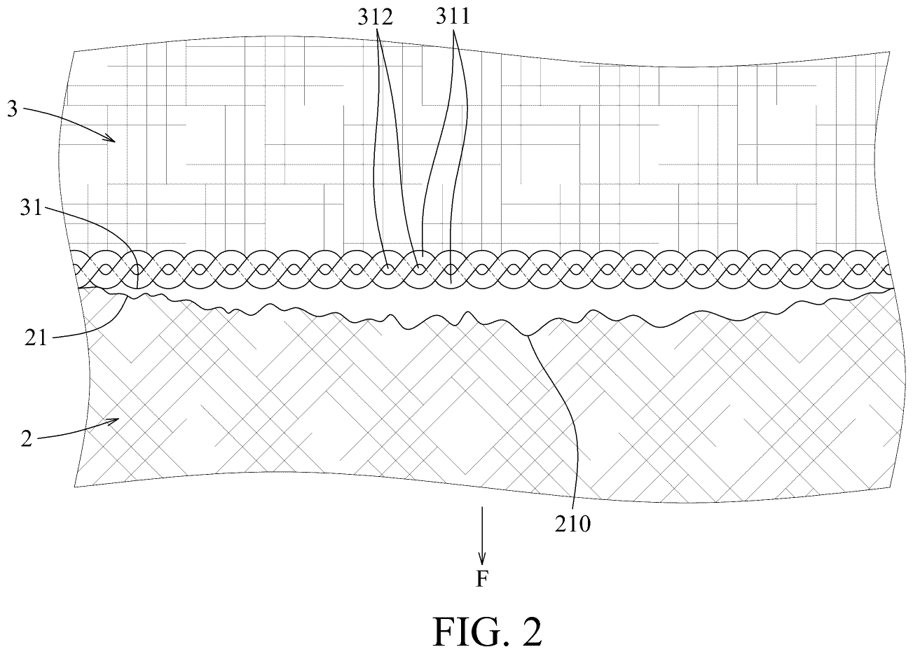

FIGS. 2 and 3 illustrate a process for manufacturing the recyclable laminate, in which the first inner surface 21 is partially fusion-bonded to the second inner surface 31.

Specifically, the first inner surface 21 of the first layer 2 is arranged to face the plurality of yarns 311 of the second inner surface 31 of the second layer 3, and then a portion of the first inner surface 21 is heated to deform into a softened region 210. The softened region 210 receives a suction force F to extend in a direction away from the second inner surface 31. After moving away from the suction force F, the softened region 210 is forced to move towards the second inner surface 31, and then extends into a portion of the micropores 312 of the plurality of yarns 311 so as to wrap the corresponding ones of the plurality of yarns 311 on the second inner surface 31 of the second layer 3. After cooling, the softened region 210 solidifies to form the bonded region 211 of the first inner surface 21 where the first inner surface 21 is directly melted and partially fusion-bonded to the second inner surface 31 in absence of an adhesive therebetween. The first inner surface is partially unbonded to the second inner surface 31 at the region other than the bonded region 211.

The process for manufacturing the embodiment of the recyclable laminate is implemented using a manufacturing system (not shown). To be specific, the first layer 2 with the first inner surface 21 facing upward is provided on a conveyer belt of the manufacturing system, and is driven to move by the conveyer belt. It should be noted that, the conveyer belt is formed with a plurality of through holes penetrating therethrough. An air suction device of the manufacturing system is disposed beneath the conveyer belt, and is configured to provide a suction force F to the first layer 2 through the plurality of through holes when the first layer 2 is driven to move by the conveyer belt. Afterwards, the second layer 3 with the second inner surface 31 facing the first inner surface 21 of the first layer 2 is provided on the first layer 2, and is driven to move with the first layer 2 by the conveyer belt. Thereafter, the first layer 2 is heated by a heating device of the manufacturing system such that the portion of the first inner surface 21 of the first layer 2 is melted and deformed into the softened region 210, which is extended by the suction force F in a direction away from the second inner surface 31. After the conveyer belt drives the first layer 2 and the second layer 3 to move away from the heating device and the suction force F provided by the air suction device, the softened region 210 is forced to move towards the second inner surface 31 due to the law of action and reaction, and then extends into the micropores 312 of the plurality of yarns 311 so as to wrap the corresponding ones of the plurality of yarns 311 on the second inner surface 31 of the second layer 3. After cooling, the softened region 210 solidifies to form the bonded region 211 of the first inner surface 21.

From the description above, it is known that in the process for manufacturing the recyclable laminate according to the embodiment of the present disclosure, the first layer 2 and the second layer 3 disposed opposite to each other are heated, such that the portion of the first inner surface 21 of the first layer 2 is melted and deformed into the softened region 210 and extends away from the second inner surface 31 upon receiving the suction force F. When moving away from the suction force F, the softened region 210 will move towards the second inner surface 31, and extends into the micropores 312 to wrap the corresponding ones of the plurality of yarns 311 on the second inner surface 31 of the second layer 3. After cooling, the softened region 210 solidifies to form the bonded region 211 that extends into the micropores 312 of the plurality of yarns 311, so that the bonding strength between bonded parts of the first inner surface 21 and the second inner surface 31 can be improved. Thus, the recyclable laminate according to the embodiment of the present disclosure has good resistance to washing and rubbing, etc.

The recyclable laminate of the present disclosure may be used for making various textile products. An example of the textile products is a recyclable garment which includes the first layer 2 and the second layer 3. The first layer 2 is a breathable waterproof thermoplastic microporous membrane, and the second layer 3 is one of a woven fabric and a non-woven fabric made of the thermoplastic material. The first layer 2 includes the first inner surface 21 having a bonded region 211, and the second layer 3 includes the second inner surface 31 facing the first inner surface 21. The second inner surface 31 includes a plurality of yarns 311 distributed thereon. The plurality of yarns 311 are interlaced with one another to form micropores 312 therebetween. The bonded region 211 of the first inner surface 21 extends into the micropores 312 of the plurality of yarns 311 to wrap corresponding ones of the plurality of yarns 311, so that the first inner surface 21 is partially fusion bonded to the second inner surface 31 at the bonded region 211 in absence of an adhesive therebetween, and is partially unbonded to the second inner surface 31 at a region other than the bonded region 211. The unbonded parts of the first and second inner surfaces 21, 31 separably contact each other. The bonded parts of the recyclable laminate of the present disclosure may be situated at peripheral parts of the first layer 2 and the second layer 3 or at the inside of the peripheral parts. Other examples of textile products made from the recyclable laminate of the present disclosure may include garment accessories such as zippers, hook-and-loop fasteners, pockets, etc.

Examples of each of the first layer 2 and the second layer 3 may include, but are not limited to, a membrane, a non-woven fabric, a plain woven fabric, a knitted fabric, a fibrous sheet, a blended yarn fabric, a three-dimensional fabric, an embossed fabric, and a resinous sheet. In order to provide the recyclable laminate of the present disclosure with a lamination configuration, the first layer 2 and the second layer 3 fusion bonded together are structurally different from each other. In addition, suitable functional materials such as waterproof and/or warming materials may be added to the first layer 2 and the second layer 3, so that the thus made textile product is conferred with various different functions.

It should be noted that, the abovementioned recyclable garment and garment accessory are made from the recyclable laminate of the present disclosure that is fabricated by partially fusion bonding the first layer 2 and the second layer 3 without use of an adhesive. Therefore, if the first layer 2 and the second layer 3 are of the same type, the recyclable garments and garment accessories, after being collected, may be directly disintegrated, washed, and dehydrated without the need to undergo sorting, and then processed into a raw particulate material. If the first layer 2 and the second layer 3 are of different types, the recyclable garments and garment accessories, after being collected, will be first subjected to sorting of the first layer 2 and the second layer 3, followed by the abovementioned steps of the recycling process, indicating that such recycling process is greatly simplified compared to conventional recycling procedures.

In summary, by virtue of the first layer 2 and the second layer 3 being made of a recyclable thermoplastic material, and the bonded region 211 of the first inner surface 21 extending into the portion of the micropores 312 of the plurality of yarns 311 of the second inner surface 31 to wrap corresponding ones of the plurality of yarns 311 in the aforesaid process, the first inner surface 21 can be partially fusion-bonded to the second inner surface 31 at the bonded region 211 without use of any adhesive such as polyurethane reactive hot melt adhesive (PUR), so that the resultant recyclable laminate of the present disclosure is not only suitable for subsequent recycling process to be reused, and thus, is environmentally friendly, but also has improved bonding strength between bonded parts of the first inner surface 21 and the second inner surface 31, and thus, is resistant to washing and rubbing, etc.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the present disclosure has been described in connection with what is considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A recyclable laminate, comprising:
a first layer including a first inner surface having a bonded region; and
a second layer including a second inner surface facing said first inner surface, said second inner surface including a plurality of yarns distributed thereon, said plurality of yarns being interlaced with one another to form micropores therebetween,
wherein said bonded region of first inner surface extends into a portion of said micropores of said plurality of yarns to wrap corresponding ones of said plurality of yarns, so that said first inner surface is partially fusion-bonded to said second inner surface at said bonded region and partially unbonded to said second inner surface at a region other than said bonded region, and
wherein said first layer and said second layer are made of a recyclable material, and are structurally different from each other.

2. The recyclable laminate as claimed in claim 1, wherein said first inner surface is partially fusion-bonded to said second inner surface in absence of an adhesive therebetween.

3. The recyclable laminate as claimed in claim 2, wherein each of said first layer and said second layer is selected from the group consisting of a membrane, a non-woven fabric, a plain woven fabric, a knitted fabric, a fibrous sheet, a blended yarn fabric, a three-dimensional fabric, an embossed fabric, and a resinous sheet.

4. The recyclable laminate as claimed in claim 2, wherein said first layer is a membrane, and said second layer is a fabric.

5. The recyclable laminate as claimed in claim 2, wherein each of said first layer and said second layer is a fabric.

6. The recyclable laminate as claimed in claim 1, wherein said first layer and said second layer are made of a thermoplastic material.

7. The recyclable laminate as claimed in claim 6, wherein said thermoplastic material is selected from the group consisting of polyethylene terephthalate, polypropylene, thermoplastic polyurethane, polyethylene, polyether ester, and thermoplastic polyamide.

8. The recyclable laminate as claimed in claim 6, wherein said first layer and said second layer constitute a garment, or a garment accessory.

9. The recyclable laminate as claimed in claim 1, wherein said first inner surface of said first layer and said second inner surface of said second layer are partially fusion-bonded by a method selected from the group consisting of hot pressing, hot air blowing, and high frequency bonding.

10. A recyclable garment, comprising:
a first layer including a first inner surface having a bonded region; and
a second layer including a second inner surface facing said first inner surface, said second inner surface including a plurality of yarns distributed thereon, said plurality of yarns being interlaced with one another to form micropores therebetween,
wherein said bonded region of said first inner surface extends into said micropores of said plurality of yarns to warp corresponding ones of said plurality of yarns, so that said first inner surface is partially fusion-bonded to said second inner surface at said bonded region in absence of adhesive therebetween, and partially unbonded to said second inner surface at a region other than said bonded region, and
wherein said first layer is a breathable waterproof thermoplastic microporous membrane, and said second layer is a woven fabric made of a thermoplastic material.
